(19) United States
(12) Patent Application Publication
(10) Pub. No.: US 2010/0033688 A1
(43) Pub. Date: Feb. 11, 2010

(54) LIGHT-SOURCE UNIT, LIGHT-SOURCE APPARATUS, AND PROJECTION-TYPE DISPLAY APPARATUS

(76) Inventors: Ryozo Obama, Osaka (JP); Tsuyoshi Ichibakase, Yamaguchi (JP)

Correspondence Address: SNELL & WILMER L.L.P. (Panasonic), 600 ANTON BOULEVARD, SUITE 1400, COSTA MESA, CA, 92626, US

(21) Appl. No.: 11/722,980

(22) PCT Filed: Jan. 19, 2006
(86) PCT No.: PCT/JP2006/001169

§ 371 Date: Jun. 27, 2007

(30) Foreign Application Priority Data
Jan. 21, 2005 (JP) 2005-014814

(51) Int. Cl. G03B 21/16; F21V 21/00; F21V 7/00

(52) U.S. Cl. 353/61; 362/362; 362/296.01; 353/52

(57) ABSTRACT

A light-source unit includes: a discharge lamp (3) that has a discharge space (13) containing mercury as a filling; and a housing (5), where the discharge lamp (3) is provided inside the housing (5). The housing (5) includes a reflecting member (7) and a lens member (9). The housing (5) includes a cutting (7e) and a through hole (43a) which enable the inside and outside of the housing (5) to communicate with each other. A cutting absorber (45a) is attached to the cutting (7e), and a through hole absorber (45b) is attached to the through hole (43a). The cutting absorber (45a) and the through hole absorber (45b) contain activated charcoal that absorbs mercury.

### TECHNICAL FIELD

The present invention relates to a light-source unit that includes a housing in which a discharge lamp containing fillings is embedded, a light-source apparatus having a discharge lamp containing fillings, and a projection-type display apparatus having a discharge lamp containing fillings.

### BACKGROUND ART

The high-pressure discharge lamp, such as the metal halide lamp, is widely used in projection-type display apparatuses, headlights of automobiles and the like. The high-pressure discharge lamp is embedded in a housing, which is formed by a reflecting member and a lens member, of a light-source unit, where the reflecting member includes a concave reflecting surface, and the lens member closes an opening of the reflecting member. The high-pressure discharge lamp has a discharge vessel that contains fillings such as a light-emitting material and a buffering material.

Incidentally, the high-pressure discharge lamp has a tendency that while it is lighted, the temperature increases, and in line with it, the pressure inside the discharge vessel increases. This tendency is prominent when the high-pressure discharge lamp is used in a light-source unit. This is because in that case, the high-pressure discharge lamp is embedded in the housing that is hermetically sealed, and the heat emitted therefrom remains in the housing, increasing the temperature of the lamp.

When the pressure in the high-pressure discharge lamp or the housing becomes excessively high, the high-pressure discharge lamp or the housing may be broken, and the parts or members near the light-source unit may be damaged by the scattered broken pieces.

One of technologies proposed as countermeasures for the above-described problem is a light-source unit in which the housing has a ventilation hole for exhausting air heated during the lighting of the high-pressure discharge lamp, to outside (see, for example, Japanese Laid-Open Patent Application No. 10-254061). The ventilation hole is structured to prevent broken pieces from being ejected to outside through the ventilation hole even if the high-pressure discharge lamp is broken. For this purpose, the ventilation hole is provided with a metal mesh, for example.

However, when the high-pressure discharge lamp as the conventional light-source unit is broken, such a conventional structure cannot prevent fillings in the discharge space of the high-pressure discharge lamp from flowing off to outside the housing.

In particular, if mercury is included in the fillings and mercury vapor escapes to outside the light-source unit, the parts and members provided around the light-source unit are eroded by the mercury. When this is taken into account in a display apparatus having a light-source unit inside, important parts such as a control unit cannot be disposed in the vicinity of the light-source unit. This gives limitations to locations at which the parts are disposed, or increases the size of the entire apparatus.

The above-described problem may also occur to some types of discharge lamps having a discharge space that contains fillings such as a light-emitting material, depending on the fillings contained therein. This is because there is a fear that such discharge lamps are broken and the fillings thereof escape to outside.

### DISCLOSURE OF THE INVENTION

It is therefore an object of the present invention to provide a light-source unit, a light-source apparatus, and a projection-type display apparatus that suppress the escape of the fillings in the discharge lamp to outside.

The above object is fulfilled by a light-source unit comprising: a discharge lamp having a discharge space containing a filling; and a housing that houses the discharge lamp, wherein the housing has a passage that causes an inside and an outside of the housing to communicate with each other, and an absorber is attached to the passage to absorb the filling that escapes from the discharge lamp.

With the above-stated construction, if, for example, the discharge lamp is broken and the filling escapes from the discharge space, the filling is absorbed by the absorber attached to the passage before the filling escape to the outside of the housing.

Accordingly, if, for example, the discharge lamp is broken and the filling escapes from the discharge space, the filling is absorbed by the absorber attached to the passage before the filling escape to the outside of the housing. Accordingly, the above-stated construction suppresses the escape of the filling to the outside of the light-source unit.

In the above-described light-source unit, the housing may include a reflecting member and a translucent member, the reflecting member may have a concave reflecting surface, the translucent member may close an opening of the reflecting member, and the reflecting member and/or the translucent member may include the passage.

With the above-stated construction, if, for example, the discharge lamp is broken during lighting and the filling escapes from the discharge space, the filling is absorbed by the absorber attached to the passage included in the reflecting member and/or the translucent member before the filling escapes to the outside of the light-source unit.

In the above-described light-source unit, the discharge lamp may be a high-pressure discharge lamp containing mercury as the filling.

It should be noted here that the term “mercury” here indicates mercury in every form including mercury in the liquid form and mercury in the vapor form.

In the above-described light-source unit, the absorber may include activated charcoal.

With the above-stated construction, the absorber can be achieved easily.

The above object is also fulfilled by a light-source apparatus comprising: a reflecting member having a concave reflecting surface; a translucent member that closes an opening of the reflecting member; and a discharge lamp that has a discharge space containing a filling, and is housed in a space surrounded by the reflecting member and the translucent member, wherein the reflecting member and/or the translucent member includes a passage that causes the space and external air to communicate with each other, and an absorber is attached to the passage to absorb the filling that escapes from the discharge space.

With the above-stated construction, if, for example, the discharge lamp is broken during lighting and the filling escapes from the discharge space, the filling is absorbed by the absorber attached to the passage before the filling escape to the outside of the housing. Accordingly, the above-stated construction suppresses the escape of the filling to the outside of the light-source apparatus.

In the above-described light-source apparatus, the discharge lamp and the reflecting member may be formed as one unit such that the discharge lamp is embedded in the reflecting member, and the reflecting member and the translucent member are attachable and detachable to/from each other.

With the above-stated construction, the discharge lamp can be changed easily as necessary.

The above object is also fulfilled by a projection-type display apparatus comprising the light-source apparatus defined above.

The above-stated construction suppresses the escape of the filling in the discharge lamp to the outside of the light-source apparatus.

The above object is also fulfilled by a projection-type display apparatus comprising: a light-source apparatus in which a discharge lamp having a discharge space containing a filling, is housed in a space that is formed by disposing a translucent member to close an opening of a reflecting member having a concave reflecting surface; an air distribution unit that cools the light-source apparatus; and a container that contains the light-source apparatus and the air distribution unit, wherein an absorber, which absorbs the filling that escapes from the discharge space, is provided in a route of air distributed by the air distribution unit at a place that is downstream of the discharge lamp.

With the above-stated construction, if the filling escapes from the discharge lamp, the escaped filling moves along the flow of air caused by the air distribution unit, and absorbed by the absorber that is provided in the route of air distributed by the air distribution unit. Accordingly, the above-stated construction suppresses the escape of the filling to the outside of the projection-type display apparatus.

In the above-described projection-type display apparatus, the reflecting member and/or the translucent member may include a passage that causes the space and external air to communicate with each other, and the absorber is attached to the passage.

With the above-stated construction, if, for example, the discharge lamp is broken during lighting and the filling escapes from the discharge space, the filling is absorbed by the absorber attached to the passage included in the reflecting member and/or the translucent member before the filling escapes to the outside of the projection-type display apparatus.

### BRIEF DESCRIPTION OF THE DRAWING

FIG. 1 is a perspective view of the light-source unit in Embodiment 1.

FIG. 2 is a front view of the light-source unit, where the lens member is removed therefrom for the sake of convenience.

FIG. 3 is a cross section of the light-source unit with the lens member mounted thereon, taken along the line X-X of FIG. 2.

FIG. 4 shows a cutting absorber.

FIG. 5 shows a discharge lamp and its surroundings in a light-source apparatus of Embodiment 2.

FIG. 6 is a cutaway perspective view of a liquid crystal projector of Embodiment 3.

FIG. 7 is a perspective view of a back-projection type image display apparatus as a modification to Embodiment 3.

FIG. 8 is an enlarged view of the light-source unit and its surroundings in the back-projection type image display apparatus.

### BEST MODE FOR CARRYING OUT THE INVENTION

### Embodiment 1

The following describes a light-source unit as the first embodiment of the present invention, with reference to the attached figures.

### 1. Construction of Light-Source Unit

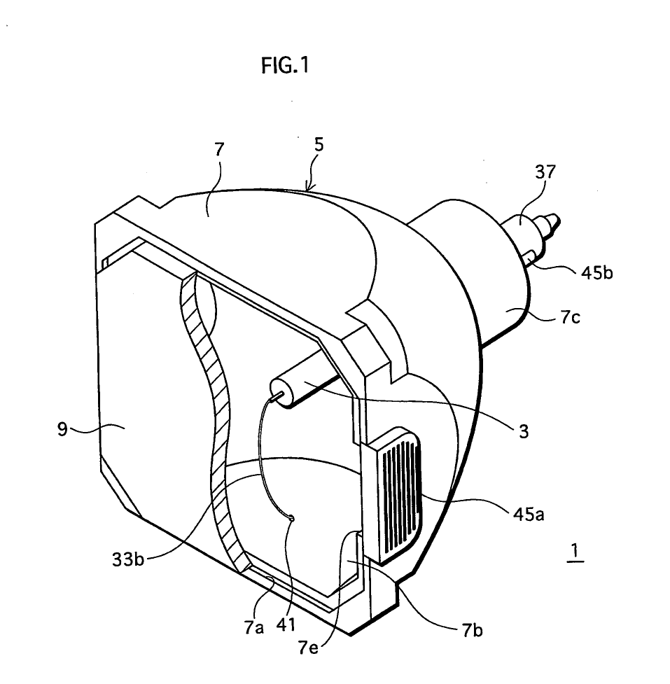

FIG. 1 is a perspective view of the light-source unit in Embodiment 1.

A light-source unit 1, as shown in FIG. 1, includes a discharge lamp 3 and a housing 5, where the discharge lamp 3 is provided inside the housing 5. The housing 5 includes a reflecting member 7 and a lens member 9 (corresponding to “translucent member” in the claims).

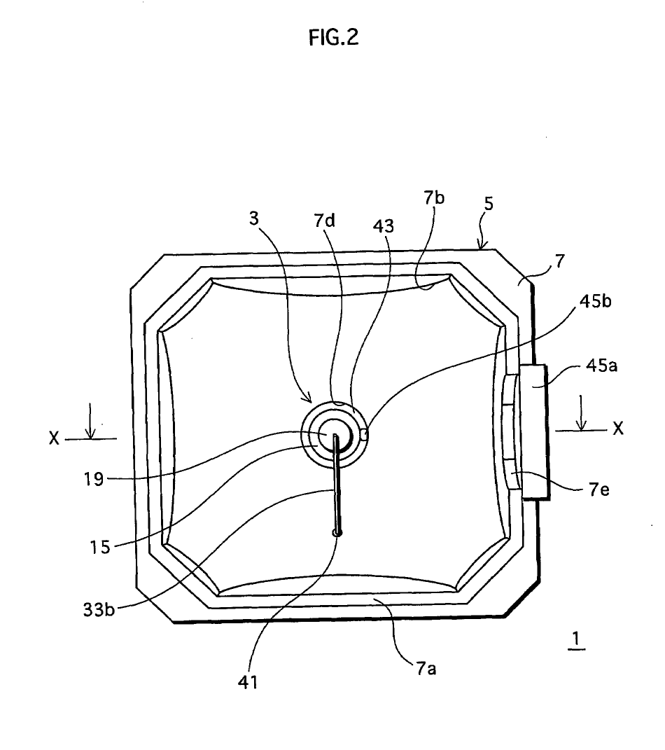

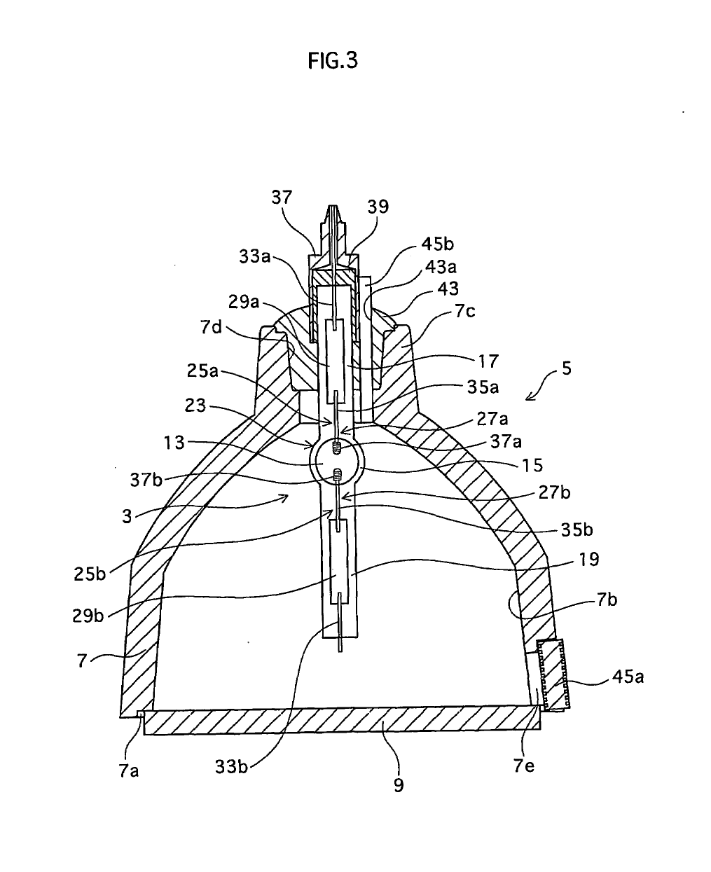

FIG. 2 is a front view of the light-source unit, where the lens member is removed therefrom for the sake of convenience. FIG. 3 is a cross section of the light-source unit with the lens member 9 mounted thereon, taken along the line X-X of FIG. 2.

The discharge lamp 3 is a well-known high-pressure discharge lamp. As shown in FIG. 3, the discharge lamp 3 includes a discharge vessel 23 and electrode assemblies 25a and 25b. The discharge vessel 23 is composed of a main tube part 15, which has a discharge space 13 therein, and two thin tube parts 17 and 19 provided on opposite sides of the main tube part 15. The electrode assemblies 25a and 25b are respectively hermetically sealed with the thin tube parts 17 and 19 such that the tips of the electrodes face each other with a distance in between in the discharge space 13.

The electrode assembly 25a is composed of an electrode part 27a, a molybdenum foil 29a, and an external lead 33a which are connected (fixed by welding, for example) to one another in the stated order. Similarly, the electrode assembly 25b is composed of an electrode part 27b, a molybdenum foil 29b, and an external lead 33b which are connected (fixed by welding, for example) to one another in the stated order. The electrode part 27a is made of tungsten and includes an electrode rod 35a and an electrode coil 37a that is wound around the electrode rod 35a at the tip thereof; and the electrode part 27b is made of tungsten and includes an electrode rod 35b and an electrode coil 37b that is wound around the electrode rod 35b at the tip thereof.

The external leads 33a and 33b are made of molybdenum and extend to outside of the discharge vessel 23 from the outer ends of the thin tube parts 17 and 19, respectively. The external lead 33b passes through a through hole 41 formed in the reflecting member 7 and extends to outside of the housing 5, as shown in FIGS. 1 and 2.

The electrode parts 27a and 27b are disposed to align substantially in a straight line to face each other in the discharge space 13. In the case of a high-pressure discharge lamp (for what is called “short arc”) that is used for a projection-type display apparatus, the distance between the electrode parts 27a and 27b, namely the inter-electrode distance is set to a range from 0.5 mm to 2.0 mm so that the light source provided between the electrode parts 27a and 27b is close to the point light source.

The main tube part 15 is filled with, for example, a light-emitting material composed of a halide such as dysprosium iodide (DyI₃), thulium iodide (TmI₃), holmium iodide (HoI₃), and/or thallium iodide (TlI), a buffering material (buffering gas) composed of mercury, and a start assist material (for example, rare gas) composed of argon and the like. In the present example of the present invention, the fillings include a light-emitting material, a buffering material, and a rare gas.

A base 37 is fixed to the outer end of the thin tube part 17 via cement 39, and the external lead 33a is connected to the base 37. It should be noted here that the base is fixed to any one of the two outer ends of the thin tube parts.

As shown in FIGS. 1 to 3, the housing 5 includes the reflecting member 7 and the lens member 9. The reflecting member 7 includes a reflecting surface 7b being a concave surface, and the lens member 9 closes an opening 7a of the reflecting member 7. The lens member 9 is bonded with the reflecting member 7 by, for example, a silicon-based adhesive.

The reflecting member 7 is, for example, a reflecting mirror whose inner surface is the reflecting surface 7b, such as a dichroic reflecting mirror. The reflecting member 7 reflects light, which comes from the main tube part 15 of the discharge lamp 3, in a predetermined direction (toward the lens member 9). The reflecting member 7 is in a shape of a funnel. As shown in FIG. 3, a through hole 7d is formed in a part (hereinafter referred to as “base part”) 7c where the opening diameter is smaller than other portions of the reflecting member 7. The thin tube part 17 of the discharge lamp 3 is partially inserted in the through hole 7d.

As the lens member 9, a glass lens is used to convert light, reflected by the reflecting surface 7b in a predetermined direction, into parallel beams of light, or to converge light.

As shown in FIG. 3, the discharge lamp 3 is fixed to the housing 5 by, for example, cement 43 while the thin tube part 17, to which the base 37 has been fixed, is partially inserted in the through hole 7d of the base part 7c of the reflecting member 7.

The housing 5 is provided with a passage that causes the inside of the housing 5 to communicate with the outside. The passage is provided with an absorber that absorbs fillings such as mercury.

More specifically, the passage includes a cutting 7e (see FIG. 1) that is substantially rectangular and is formed by cutting an inner side surface of the reflecting member 7 from the opening 7a to the base part 7c, and includes a through hole 43a (see FIG. 3) that is formed along the thin tube part 17 of the discharge lamp 3, between the base part 7c of the reflecting member 7 and the thin tube part 17 of the discharge lamp 3.

An absorber (hereinafter referred to as “cutting absorber”) 45a is attached to the cutting 7e. The cutting absorber 45a is in a shape of a thin box to fit the shape of the cutting 7e. It should be noted here that the cutting 7e changes stepwise in size in the thickness direction of the reflecting member 17, and the cutting absorber 45a is fit into the outermost portion, which is the largest portion, of the cutting 7e in a detachable manner.

Also, an absorber (hereinafter referred to as “through hole absorber”) 45b is attached to the through hole 43a. The through hole absorber 45b is in a shape of a rod to fit the shape of the through hole 43a. The through hole absorber 45b is attached to the reflecting member 7 (in the actuality, to the cement 43) while it is inserted in the through hole 43a.

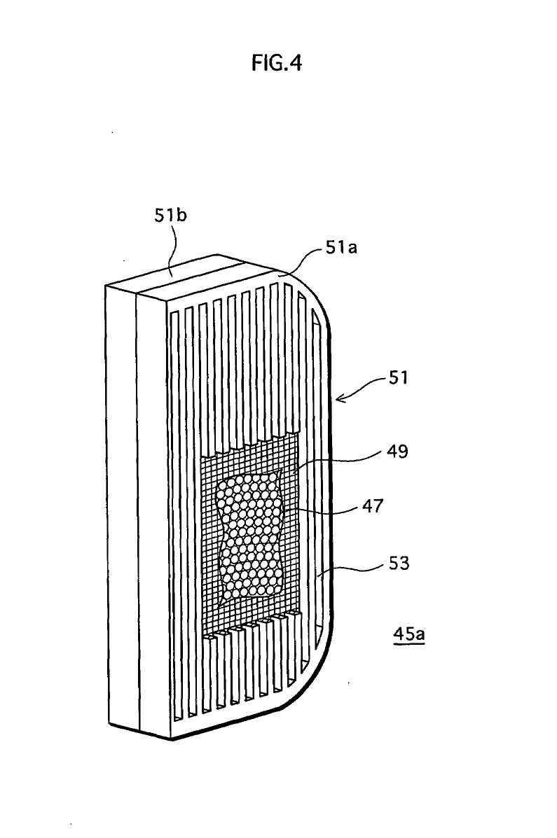

FIG. 4 shows a cutting absorber.

As shown in FIG. 4, the cutting absorber 45a includes activated charcoal grains 47, a meshed bag 49 for housing the activated charcoal grains 47, and a container 51 for housing the meshed bag 49 together with the activated charcoal grains 47 such that they are replaceable. The container 51 is formed by, for example, putting two container members 51a and 51b, which are lidless containers, such that the openings of the container members 51a and 51b face each other, thus forming a space for housing the activated charcoal grains inside. The side walls of the container members 51a and 51b are each provided with a passage (for example, a slit 53) that causes the air to flow in the thickness direction of the container 51.

It should be noted here that the cutting absorber 45a attached to the reflecting member 7 is not necessarily be detachable. For example, one of the container members (for example, container member 51b) of the cutting absorber 45a may be fixed to the reflecting member 7 by cement or the like. In this case, the pair of container members 51a and 51b may be structured to be openable and closable so that the activated charcoal 47 can be replaced while the container member 51b is fixed to the reflecting member 7.

Also, the container members 51a and 51b may be fixed to each other. In this case, the activated charcoal 47 inserted therein cannot be replaced.

It should be noted here that the through hole absorber 45b, as is the case with the cutting absorber 45a, includes activated charcoal, a bag, and a container. The container is in a shape of a hollow circular cylinder so that the container can be filled with the activated charcoal. The top and bottom walls of the cylindrical container are provided with through holes such that air can pass through the cylindrical container.

### 2. Acts

The light-source unit 1 with the above-described construction has a structure that enables the inside and outside of the housing 5 to communicate with each other via the cutting 7e and the through hole 43a. The absorbers 45a and 45b that are attached to the cutting 7e and the through hole 43a allow air to pass through themselves. With this structure, it is possible to release the heat, which is generated as the discharge lamp 3 is lighted, to outside the housing 5 via the cutting 7e and the through hole 43a. This structure therefore prevents the discharge lamp 3 from increasing in temperature while it is lighted. This prevents the discharge lamp 3 from having a short life (including a short life due to breakage).

When the discharge lamp 3 is broken while it is lighted, and the fillings, for example, mercury, are released from the discharge space 13, the fillings would escape to the outside of the housing 5 via the cutting 7e and the through hole 43a. However, since the absorbers 45a and 45b are attached to the cutting 7e and the through hole 43a, mercury, which would flow out to the outside of the housing 5 via the cutting 7e and the through hole 43a, is absorbed by the absorbers 45a and 45b. In this way, this structure prevents mercury from escaping to the outside of the housing 5, preventing leakage of mercury from the light-source unit 1.

### Embodiment 2

The following describes a light-source apparatus as the second embodiment of the present invention, with reference to the attached figures.

The light-source apparatus uses a discharge lamp as the light source.

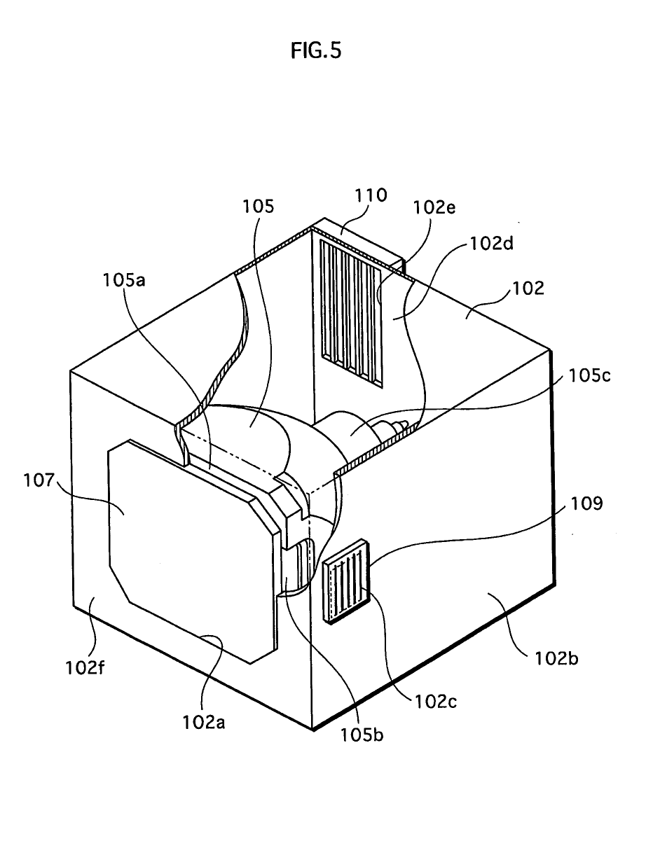

FIG. 5 shows a discharge lamp and its surroundings in a light-source apparatus.

As shown in FIG. 5, the light-source apparatus includes a light-source housing unit 102 that is in a shape of a cube. Inside of the light-source housing unit 102, the light-source apparatus further includes a reflecting member 105 and a translucent lens member 107. The reflecting member 105 includes a reflecting surface being a concave surface, and the lens member 107 closes an opening of the reflecting member 105. The discharge lamp is housed in a space surrounded by the reflecting member 105 and the lens member 107.

The reflecting member 105, the lens member 107, and the discharge lamp described in Embodiment 2 have the same construction as the reflecting member 7, the lens member 9, and the discharge lamp 3 described in Embodiment 1.

In the present embodiment, the lens member 107 is fixed into an opening 102a of a wall 102f on the front side of the light-source housing unit 102. The discharge lamp is embedded in the reflecting member 105 as one unit. The assembly of the discharge lamp and the reflecting member 105 (the assembly is referred to as a “lamp unit”) is forced forward such that a rim 105a of the reflecting member 105 is connected to the lens member 107 and the lamp unit is fixed to the inside of the light-source housing unit 102. In this case, it is required to change the whole lamp unit to change the discharge lamp.

When the opening of the lamp unit (the opening surrounded by the rim 105a) is closed by the lens member 107, a space surrounded by the lens member 107 and the reflecting member 105 is created in the lamp unit. Together with the space, a passage that causes the space and external air to communicate with each other is also created. The passage, as is the case with Embodiment 1, includes a cutting 105b that is formed in the reflecting member 105 on the lens member 107 side, and includes a through hole that is formed in the reflecting member 105 on the base part 105c side.

The light-source housing unit 102 is in a shape of a cube, and has passages that are formed in its wall at locations near the passages of the lamp unit. Each of the passages of the light-source housing unit 102 is provided with an absorber that includes activated charcoal.

More specifically, a communicating hole 102c is formed in a wall 102b at a position near the cutting 105b, and an absorber 109 is provided to cover the communicating hole 102c, on an outer surface of the light-source housing unit 102. Also, a communicating hole 102e is formed in a wall 102d at a position near the through hole of the reflecting member 105 formed on the base part 105c side, and an absorber 110 is provided to cover the communicating hole 102e, on an outer surface of the light-source housing unit 102.

It should be noted here that the inside and outside of the light-source housing unit 102 can communicate with each other only via the communicating holes 102c and 102e that are formed in the walls 102b and 102d, respectively.

As is the case with Embodiment 1, the light-source apparatus of Embodiment 2 is also constructed such that when the discharge lamp is broken while it is lighted, and mercury or mercury vapor escapes to outside the space surrounded by the reflecting member 105 and the lens member 107, the mercury or mercury vapor fails to escape to the outside of the light-source housing unit 102 since the mercury or mercury vapor is absorbed by the absorbers 109 and 110.

In the above-described light-source apparatus of Embodiment 2, the lens member 107 is provided in the light-source housing unit 102, and the lamp unit is attached in a detachable manner to the light-source housing unit 102. However, not limited to this structure, for example, an assembly of a lens member and a reflecting member may be provided in a light-source housing unit, and a discharge lamp may be attached in a detachable manner to the reflecting member.

### Embodiment 3

The following describes a front-projection type image display apparatus (hereinafter referred to as “liquid crystal projector”) as the third embodiment of the present invention, with reference to the attached figures.

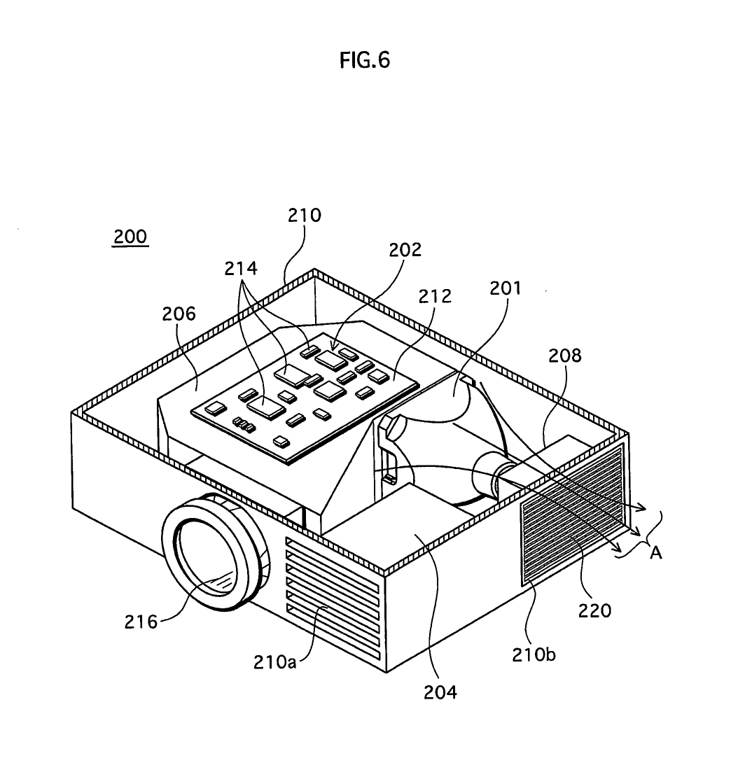

FIG. 6 is a cutaway perspective view of a liquid crystal projector of Embodiment 3.

As shown in FIG. 6, a liquid crystal projector 200 includes: a light-source unit 201 that includes a discharge lamp inside; a power unit 202 that includes an electronic ballast for lighting the discharge lamp; a control unit 204; a lens unit 206 in which a converging lens, a translucent color liquid crystal display plate, and a driving motor are embedded; a fan apparatus 208 for cooling; and a case 210 that houses these components. It should be noted here that the lens unit 206 is arranged such that part of it extends to outside of the case 210.

The power unit 202 generates a predetermined direct-current voltage from a 100V home alternating-current power supply, and supplies the generated direct-current voltage to the electronic ballast, the control unit 204, and the like. The power unit 202 includes: a board 212 disposed on the lens unit 206; and a plurality of electronic/electric components 214 mounted on the board 212.

The control unit 204 drives the color liquid crystal display plate so as to display a color image based on the image signals input from outside. The control unit 204 also controls the driving motor in the lens unit 206 so as to perform a focusing operation and a zooming operation.

The light beams emitted from the light source unit 201 are converged by the converging lens inside the lens unit 206 and pass through the color liquid crystal display plate disposed in the light path. With this operation, an image formed on the color liquid crystal display plate is projected onto a screen (not illustrated) via the lens 216 and the like.

In the liquid crystal projector 200 having the above-described construction, passages 210a and 210b are provided in the front and side walls of a case 210 such that air flows, especially around the light-source unit 201, inside the case 210 to cool the discharge lamp (light-source unit 201) during lighting. Further, a fan apparatus 208 is provided to forcibly exhaust air outside from the case 210. The arrows in FIG. 6 indicate a route (hereinafter referred to as “air flow route”) A of the air caused to flow out from the case 210 by the fan apparatus 208. The arrows are provided to assist the understanding of how the air flows out, and in the actuality, air flows in other ways as well.

As is the case with Embodiment 1, the light-source unit 201 includes a discharge lamp, a reflecting member, and a lens member. The discharge lamp is embedded in a housing that is composed of the reflecting member and the lens member. The light-source unit 201 is disposed in the air flow route A.

As is the case with Embodiment 1, a passage is provided in the light-source unit 201 to cause the inside and outside of the housing to communicate with each other. Different from Embodiment 1, no absorbers (45a and 45b) are attached to the passage.

The fan apparatus 208 is attached to the passage 210b that is downstream of the light-source unit 201 in the air flow route. Also, a filter (not illustrated) for preventing dust from entering into the case 210 is provided in the passage 210a. On the other hand, the passage 210b is provided with an absorber 220 using activated charcoal. It should be noted here that the absorber 220 also has a function to prevent a human hand or the like from entering into the case 210, especially into the fan of the fan apparatus 208.

As is the case with the other embodiments, the liquid crystal projector 200 of Embodiment 3 is also constructed such that when the discharge lamp in the light-source unit 201 is broken and mercury escapes to outside, the mercury is absorbed by the absorber 220 attached to the case 210. This reduces the fear that the parts and members, especially those of the power unit 202 having the electronic/electric components 214, are eroded by mercury. This enables, for example, the power unit 202 having the electronic/electric components 214 to be disposed at a place near the light-source unit 201 (upstream of the fan apparatus 208 in the air flow route).

In Embodiment 3, a front-projection type image display apparatus is used as the image display apparatus that includes the lamp of the present invention. However, not limited to this, the present invention can be applied to, for example, a back-projection type image display apparatus.

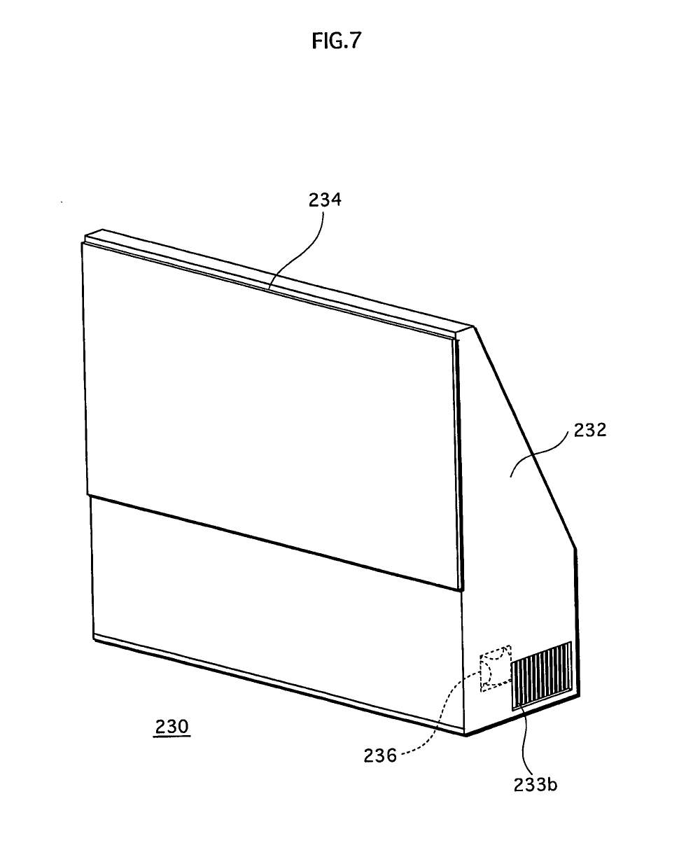

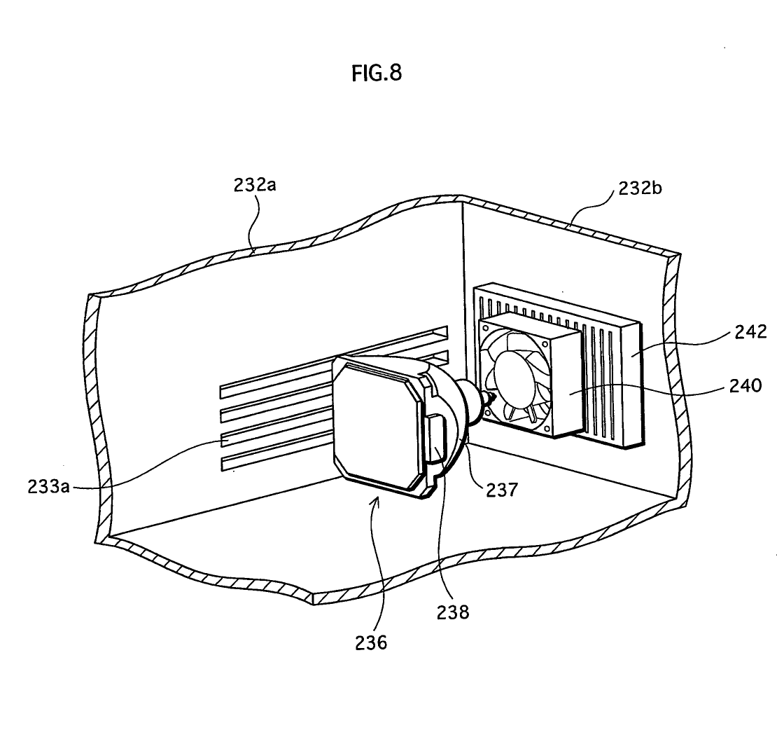

FIG. 7 is a perspective view of a back-projection type image display apparatus. FIG. 8 is an enlarged view of the light-source unit and its surroundings.

A back-projection type image display apparatus 230 includes: a cabinet 232; a screen 234 which, disposed on the front surface of the cabinet 232, displays images or the like; and a light-source unit 236 disposed inside the cabinet 232. It should be noted here that the light-source unit 236 has the same specifications as the light-source unit described in Embodiment 1, and that an absorber 238 is attached to a reflecting member 237.

As shown in FIG. 8, a passage 233a is provided in a back wall 232a of the cabinet 232 at a position close to the light-source unit 236. Also, as shown in FIG. 7, a passage 233b is provided in a side wall 232b of the cabinet 232 at a position close to the light-source unit 236.

An absorber 242 is attached to the inner surface of the side wall 232b of the cabinet 232 to cover the passage 233b. Also, a fan apparatus 240 is provided between the absorber 242 and the light-source unit 236 so as to cause the air, which has been heated by the lighting of the light-source unit 236, to flow out to the outside of the cabinet 232 via the passage 233b.

Up to now, the present invention has been described through the embodiments thereof. However, the present invention is not limited to the embodiments, but can be modified in a variety of ways. The following provides examples of such modifications.

### (1) Discharge Lamp

In each of the above-described embodiments, a high-pressure discharge lamp for a liquid crystal display apparatus, namely a metal halide lamp of a short-arc type having a short inter-electrode distance is used as the discharge lamp. However, the present invention is also achieved by using (a) a high-pressure mercury lamp of a short-arc type, or (b) a metal halide lamp or a high-pressure mercury lamp of a type that has a long inter-electrode distance. Also, such a metal halide lamp or a high-pressure mercury lamp may be a single-ended type or a double-ended type. Also, a halogen light may be used as the discharge lamp.

It is preferable that the discharge lamp of the present invention is used as a lamp that contains mercury, or as a lamp in which the mercury vapor pressure in the arc tube increases during lighting, where mercury, if it escapes from the discharge lamp, may erode other materials near the lamp.

It should be noted here that absorbing mercury is helpful for protecting the environment since mercury vapor has a property of eroding other materials. From this point of view, the present invention is applicable to a low-pressure mercury discharge lamp using mercury, for example, a fluorescent lamp, a light-bulb-type fluorescent lamp or the like.

### (2) Passage

In Embodiment 1, the passage is achieved as a cutting that is formed by cutting the reflecting member on the opening side. However, not limited to this, the passage may be achieved in other forms, for example, as a through hole that passes through the reflecting member, or as a combination of a cutting and a through hole.

The passage may be provided in the translucent member, as well as in the reflecting member. The passage provided in the translucent member is not limited to a specific shape or form. The passage may be separately provided in both the translucent member and the reflecting member. Also, the passage may be provided to bridge over the translucent member and the reflecting member.

In Embodiment 1, two passages were provided in the reflecting member; and in Embodiment 2, two passages were provided in the light-source housing unit. However, the number of the passages of the present invention is not limited to two, but may be one or three or more. It is preferable that two or more passages are provided, when the ventilation is taken into account.

### (3) Fillings

in the above-described embodiments, the absorber is used to absorb mercury. However, the present invention is applicable to absorbing other materials filled in the lamp. For example, if a metal halide lamp is used as the discharge lamp, the light-emitting material filled in the arc tube may include a halide such as dysprosium iodide (DyI₃), thulium iodide (TmI₃), holmium iodide (HoI₃), or thallium iodide (TlI)

### (4) Absorber

In the above-described embodiments, activated charcoal grains are used as the material that absorbs mercury. However, not limited to this, activated charcoal fiber or activated charcoal paper may be used as the material for absorbing mercury. Also, absorber material grains obtained by tearing the activated charcoal fiber or activated charcoal paper may be used as the material for absorbing mercury.

Further, the activated charcoal grains or the absorber material grains may be distributed and mixed into the activated charcoal fiber or the activated charcoal paper for use. With such a method, the absorber is increased in area, enhancing the advantageous effect of absorbing mercury. Also, any form of a mixture of grains, fiber, and paper may be used for absorbing mercury.

When the activated charcoal fiber is used, it may be housed in a bag as in the above-described embodiments, or a cloth made of the activated charcoal fiber may be housed directly in the container.

Furthermore, a fiber may be made from a metal material (Al, Ti, Mn, Fe, Ni, Cu, Zn, Nb, Mo, Ag, W, Pt, and/or Au) and/or a glass material (quartz and/or silicate of soda), and the fiber may be used in the absorber (for example, in a form of a cloth that is made from the fiber). In this case, only one type of fiber may be used, or a combination of a plurality of types of fibers may be used.

### (5) Locations of Absorbers

In Embodiment 1, the light-source unit is provided with the absorbers; in Embodiment 2, the light-source housing unit, not the light-source unit, is provided with the absorbers; and in Embodiment 3, the absorber is housed in a case, where the light-source unit of the display apparatus does not house the absorber. However, the absorber of the present invention is not limited to specific locations in so far as the absorber can absorb a material that escapes from the discharge lamp when the discharge lamp is broken.

### (6) Reflecting Member and Translucent Member

The reflecting member in the above-described embodiments may be achieved as (i) a reflecting mirror that is formed of borosilicate glass or crystallized glass and has a reflecting surface deposited with a dielectric multilayer or aluminum, or (ii) a reflecting mirror that is formed of a metal such as aluminum and has a reflecting surface deposited with a dielectric multilayer or aluminum, or the like.

In the above-described embodiments, the translucent member is achieved as a glass lens that converts light, reflected by a reflecting surface in a predetermined direction, into parallel beams of light, or as a glass lens that converges light. However, the translucent member may be achieved merely as a transmission member such as a mere glass plate that transmits light reflected by a reflecting surface. Also, the translucent member may be achieved as a reflecting plate of a lighting apparatus that is equipped with a fluorescent lamp or the like.

### (7) Light-Source Apparatus

In the light-source apparatus of Embodiment 2, the discharge lamp and the reflecting member are formed as one unit such that the discharge lamp is embedded in the reflecting member. The assembly of these is attached to the translucent member (light-source housing unit) that constitutes the light-source apparatus.

However, the light-source apparatus of the present invention is not limited to the above-mentioned structure, but may have any structure in so far as it includes at least the discharge lamp, the reflecting member, and the translucent member. For example, the discharge lamp and the reflecting member may be separately provided, and they may be attached to the translucent member that constitutes the light-source apparatus.

The light-source apparatus described here may be used for various apparatuses other than display apparatuses. For example, the light-source apparatus of the present invention may be used in a headlight of an automobile. In this case, if the discharge lamp is broken and mercury vapor escapes from the discharge vessel, the mercury vapor is absorbed by the absorber. This structure accordingly reduces the possibility that the reflecting mirror of the headlight or car components made of iron or the like are eroded by the mercury.

### (8) Others

In the above-described embodiments, it is presumed that the discharge lamp is broken as the temperature rises during lighting. However, the discharge lamp may be broken for other reasons. For example, during a transfer, the light-source unit, light-source apparatus, or projection-type display apparatus may receive a load and may be broken due to this, or cracks may occur between the electrode assembly and the discharge vessel as the discharge lamp comes to the end of the life (such a case is included in the breakage). In such cases, the light-source unit, light-source apparatus, and projection-type display apparatus of the present invention can prevent the fillings in the discharge lamp from flowing out to the outside thereof.

### INDUSTRIAL APPLICABILITY

The present invention is applicable to a light-source unit, alight-source apparatus, and a display apparatus that can suppress the escape of the fillings to outside from the discharge space.

1. A light-source unit comprising:
a discharge lamp having a discharge space containing a filling; and
a housing that houses the discharge lamp, wherein
the housing has a passage that causes an inside and an outside of the housing to communicate with each other, and an absorber is attached to the passage to absorb the filling that escapes from the discharge lamp.

2. The light-source unit of claim 1, wherein
the housing includes a reflecting member and a translucent member, the reflecting member has a concave reflecting surface, the translucent member closes an opening of the reflecting member, and the reflecting member and/or the translucent member includes the passage.

3. The light-source unit of claim 2, wherein
the discharge lamp is a high-pressure discharge lamp containing mercury as the filling.

4. The light-source unit of claim 1, wherein
the discharge lamp is a high-pressure discharge lamp containing mercury as the filling.

5. The light-source unit of claim 1, wherein
the absorber includes activated charcoal.

6. The light-source unit of claim 4, wherein
the absorber includes activated charcoal.

7. A light-source apparatus comprising:
a reflecting member having a concave reflecting surface;
a translucent member that closes an opening of the reflecting member; and
a discharge lamp that has a discharge space containing a filling, and is housed in a space surrounded by the reflecting member and the translucent member, wherein
the reflecting member and/or the translucent member includes a passage that causes the space and external air to communicate with each other, and an absorber is attached to the passage to absorb the filling that escapes from the discharge space.

8. The light-source apparatus of claim 7, wherein
the discharge lamp and the reflecting member are formed as one unit such that the discharge lamp is embedded in the reflecting member, and the reflecting member and the translucent member are attachable and detachable to/from each other.

9. A projection-type display apparatus comprising the light-source apparatus defined in claim 7.

10. A projection-type display apparatus comprising:
a light-source apparatus in which a discharge lamp having a discharge space containing a filling, is housed in a space that is formed by disposing a translucent member to close an opening of a reflecting member having a concave reflecting surface;
an air distribution unit that cools the light-source apparatus; and
a container that contains the light-source apparatus and the air distribution unit, wherein
an absorber, which absorbs the filling that escapes from the discharge space, is provided in a route of air distributed by the air distribution unit at a place that is downstream of the discharge lamp.

11. The projection-type display apparatus of claim 10, wherein
the reflecting member and/or the translucent member includes a passage that causes the space and external air to communicate with each other, and the absorber is attached to the passage.

12. A projection-type display apparatus comprising the light-source apparatus defined in claim 8.
